(19) United States
(12) Patent Application Publication
(10) Pub. No.: US 2017/0034132 A1
(43) Pub. Date: Feb. 2, 2017

(54) System and method for optimizing the transmission of data associated to an impersonal identifier of the receiver

(71) Applicant: Victor-Vartan Pambuccian, Bucharest (RO)

(72) Inventor: Victor-Vartan Pambuccian, Bucharest (RO)

(21) Appl. No.: 15/213,417

(22) Filed: Jul. 19, 2016

(30) Foreign Application Priority Data
Jul. 30, 2015 (RO) A/00555

(51) Int. Cl. H04L 29/06; G06K 7/14; G06K 7/10; H04L 29/08; G06F 21/62

(52) U.S. Cl. CPC H04L 63/0414; H04L 67/06; H04L 67/42; G06F 21/6263; G06K 7/10366; G06K 7/1417

(57) ABSTRACT

System and method for optimizing the transmissions of data associated to an impersonal identifier of the receiver, made of an architecture on which the computer software implementing the optimization method runs, including an emitter which “is made aware” by several possible means of the receiver's impersonal identifier II, and which transmits the relevant data to the receiver, an input device for the II, and the various types of data transmitted by the emitter, an operative memory OM where every bijective pair of personally identifiable information PII is stored, respectively impersonal identifier II, a central computer with server function receiving II and data from the emitter and using the PII associated with II transmits the data together with PIT to the receiver by a Communication Service Provider CSP, an output device to transmit data to a receiver, known in itself, and in order to optimize the technical functional parameters of the system, a sub-system called Personal Data Manager PDM running on the said server.

### I BACKGROUND OF THE INVENTION

1. Field of the Invention

The invention refers to an IT system which allows the optimal reception and transmission of data, and to a computer-implemented method of optimization of the data reception and transmission using techniques of depersonalization of the receiver's personal identifiable information PIT, whose result is to obtain technical effects related to the improvement of system operating performances, and, in addition, to minimize the possibility of “malicious” use by the unauthorized third parties of the data managed by the system.

The personally identifiable information PII includes names, mailing addresses, email addresses, phone numbers and, in general, any data belonging to a receiver, which it will not publish but to a very limited number of emitters, because it discloses a person's identity.

2. Description of the Related Art

There are data transmission systems and methods where the personal information may be identified and become publicly available, for instance by the fact that the electronic mail addresses (e-mail) or phone numbers have been communicated to certain persons, and this information may be subsequently used very easily in a malicious or even destructive way, such as by sending unwanted messages (spam), viruses or threats.

Products and methods are currently used that allow a receiver to create temporarily available personal data, but which have the disadvantage that users must generate once again such personal data when the older ones are compromised or expire. Moreover, the received data may be irrecoverably lost if the temporarily available personal data expires and is deleted by the server.

Likewise, IT systems and data transmission computer implemented methods are known where the identifier's personal information is not transmitted and/or impersonal identifiers II are generated which are afterwards used in the system.

Thus, in a previously known solution, the related system and method for generating and transmitting data without personally identifiable information are based on the association between one or several impersonal identifiers and personal data of identification of a client with the purpose to aggregate additional data from various external sources without disclosing such personally identifiable information. The disadvantage of this solution is that it cannot be used to transmit data towards external communication systems (such as, for instance, email systems), but only to collect data from external data storage systems.

Another known solution is based on the generation, in terms of network device (router/access point), of a sole identifier that will be sent together with the following re-source requests into the network to be able to correlate them, so that it will enable the outlining of a profile of user preferences performing these applications in the network. The disadvantage of this solution consists in the fact that the sole identifiers do not have a bijective association with personal identification information (such as email addresses, phone numbers) but only information such as “network navigation request”, which cannot be used to transmit data to external communication systems.

The technical problem that the invention solves consists in the optimization of the technical parameter assembly of operation of the data reception and transmission system that is mainly expressed by:
reducing the risk of data transmission errors to a wrong receiver, unless the impersonal identifier II is manually introduced;
optimizing the storage space on the emitters' devices due to the more reduced size of the impersonal identifier II associated to personally identifiable information PII compared to their size;
reducing PII validation errors;
reducing the time to insert receiver data, unless the II is manually inserted.

### II SUMMARY OF THE INVENTION

The data reception and transmission optimization IT system by depersonalization of personally identifiable information PII of the receiver, according to the invention, eliminates the previously mentioned disadvantages by the fact that it is made of an architecture that includes an emitter which, “is notified” by several ways by an impersonal identifier II of the receiver and which sends relevant data to the receiver, an input device for the impersonal identifier II and the various types of data transmitted by the emitter, an operative memory OM where every bijective pair of personally identifiable information PIT is stored, and, respectively, II, a central computer acting as a server, taking over the, “depersonalized” transmitted data and using the bijective pair of the impersonal identifier, sends them together with the identifiable personal data through a Communication Service Provider CSP, an output device for the transfer of data to a receiver, known in itself, and in order to optimize the functional technical parameters of the system, a sub-system called Personal Data Manager PDM running on the reminded server.

The system gives every DIP an impersonal identifier II unique in the system, so that the receiver may publish it, and the emitter will no longer need the receiver's PII to transmit data. An effect of this connection consists in the elimination of the need to publicly expose PII and their protection as private data.

The method to optimize the reception and transmission of data by depersonalization of the receiver's personally identifiable information, according to the invention, eliminates the previously mentioned disadvantages by the fact that it supposes the taking of the following steps:
a) introduce personally identifiable information PII in the system, generate an impersonal identifier II that is unique in the system, and memorize the associated bijective PII-II pair in an operative memory;
b) transmit data by the emitter in the system by using II generated in the previous step;
c) process data in the system, by validation and association with the corresponding PII, and transmit data to a receiver output device according to the associated PII.

By applying the invention, the following advantages will be obtained:
use the method to transmit data to external communication systems, such as email systems, by bijective association of sole impersonal identifier with personally identifiable information PII of a receiver;
reduce the risk to transfer data to a wrong receiver, if the impersonal identifier II is not manually introduced;
optimize the storage area on the emitters' devices due to the smaller size of II associated to PII compared to their usual size;
reduce the PII validation errors and reduce the receiver data introduction time, if the II of the receiver is not introduced manually.

### III BRIEF DESCRIPTION OF THE FIGURES

FIG. 1—Overall system architecture;

FIG. 2—Detailed system architecture illustrating the manner to transfer data in the system;

FIG. 3—Structure of the Personal Data Manager software subsystem;

FIG. 4—Block diagram including the steps of the method of optimization for transmitting the receiver's personal identifiable information

### IV DETAILED DESCRIPTION OF THE INVENTION

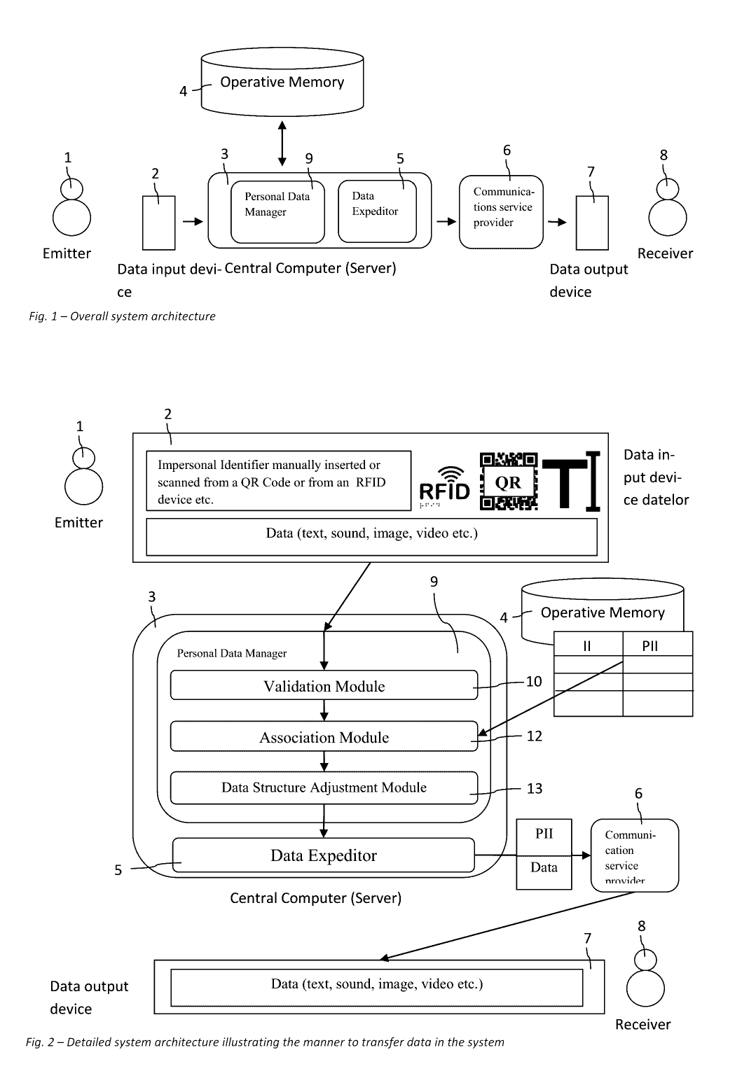

The system presented as overall architecture in FIG. 1 and respectively as detailed architecture in FIG. 2 is made of an emitter 1 of data which may be taken over by the impersonal identifier II according to different and known introduction manners, an input device 2 of data to be transmitted by emitters and associated to a II unique in the system, a central computer 3 with server function destined to the processing of data in the system, as regards the validation and associations with the corresponding PII and transmission to a receiver output device according to the associated PII, with a permanent operative memory 4 destined to memorization II associated to PII, a data expeditor 5 DE sending data by using PII to a Communication Service Provider CSP 6 and an output device 7 to take over data by receiver 8, architecture known in itself, and where the central computer 3 incorporates the Personal Data Manager sub-system 9, which has the function to optimize the operational technical parameters of the system by using a, “depersonalization” procedure of the specific PII.

The central computer 3 with server function may be any kind of computer, such as Computer, Microcomputer, Minicomputer, Mainframe, Laptop, Tablet PC or Handheld Computer, or any device with a general or specialized architecture to accomplish the system functions.

A first example of accomplishment corresponds with the manual insertion of data, where emitter 1 introduces II of the receiver in a control in the interface of the input device, for instance a text box, and chooses the data that must be transferred (text, sound, image, video, etc.).

Another example of accomplishment corresponds with the case when II is stored in a RFID device (Radio-Frequency Identification), which is read by the input device of emitter 1 and automatically associated with the emitter's request to the central computer, so that the emitter selects the data that must be sent.

According to a third example of accomplishment, emitter 1 has the function that II may be stored, on its own or included in a URI address (Uniform Resource Indicator), in a QR code (Quick Response). Thus, if II is stored in an URI address in QR code, then the emitter scans the QR code, which may be led directly to an Internet page where it must choose the data that must be sent to the central computer, and II will be automatically associated with the transmission request.

The recording II on the server and the transfer of data may be made by any input device 2, respectively by any output device 7 that may communicate with the central computer 3. Several examples may include tablets, PCs, laptops and smart phones.

The emitter 1 and receiver 8 that are integrated to the system may technically be of a significant number and of the same type, or of a different type. They may be connected to the server directly or indirectly through a network, both wired” (by cable), and, “wireless” (without cables). Examples of protocols used in “wired” connections may be Ethernet or Token Ring. Examples of work technologies in “wireless” connections suitable for the implementation of the invention are WiFi, Bluetooth, Near Field Communication (NFC), Contactless and infra-red (IR).

The operative memory 4 stores both PII and II, and the association of every identifiable personal data PII with the associated impersonal identifier II.

The communication service provider CSP 6 is the entity that issues receiver's PII, and has the function to send data to a receiver device according to this PII. The communication service provider may be an electronic mail service, a phone company, etc.

On the central computer 3, the Data Expeditor service runs—DE 5, known as such, and the Personal Data Manager sub-system PDM 9.

The Data Expeditor service DE 5 sends messages that contain data and PII to the communication service provider CSP 6. The DE service may run on the same central computer as PDM or on another computer. There are many types of data expeditors, corresponding to the types of communication service providers. Examples of communication services are electronic mail and SMS (Short Message Service). According to the receiver's PII and to the configuration of the central computer, the data will be sent by one or several expeditors.

It is recommended that the data is encrypted by the emitter's device and decrypted by PDM before being sent to DE. Similarly, it is recommended that, during the recording of PII, it should be encrypted by the receiver's device and decrypted by PDM.

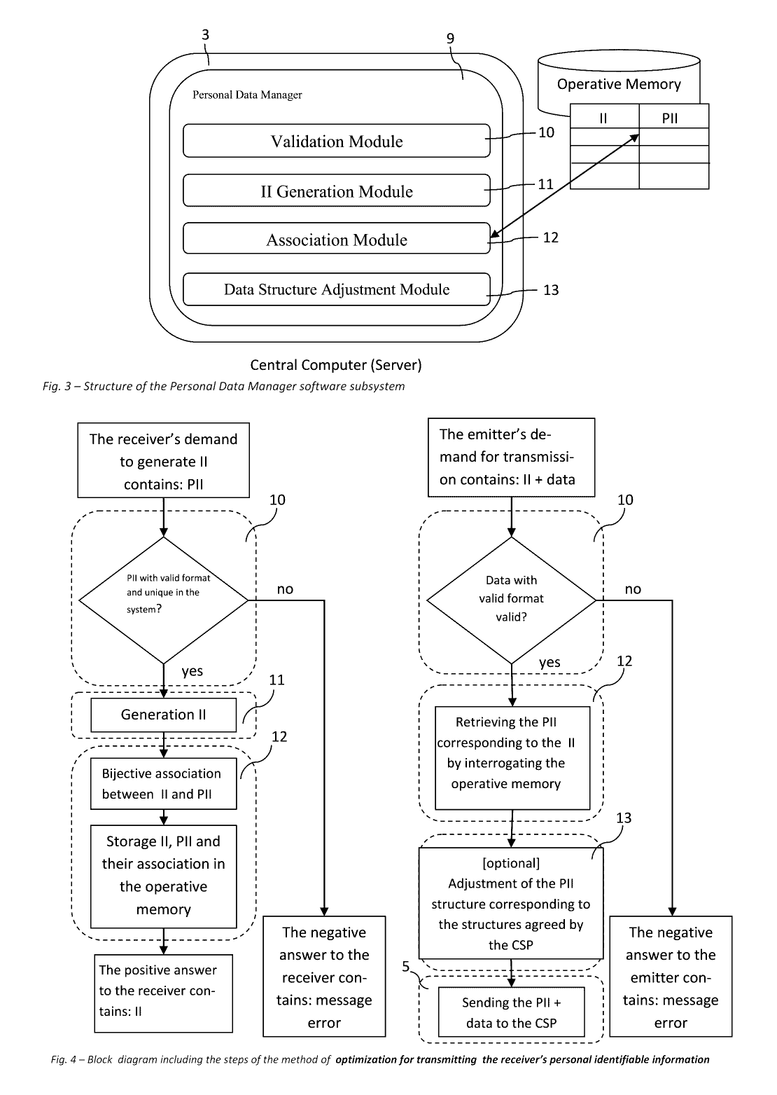

The Personal Data Manager subsystem PDM—according to FIG. 3—has as function the optimization of the technical working parameters of the system, by “depersonalization” of the personal data, and it includes a Data Validation Module DVM 10, an Impersonal Identifier Generation Module IIGM 11, an Association Module AM 12 of PII with the impersonal identifier II and a Formatting Module FM 13 of PII in a format accepted by the communication service provider CSP.

The PDM sub-system executes the requests to record or amend personally identifiable information PII and the requests to transfer data to receivers.

PDM allows adding, deleting and changing PII, as well as to replacing the II with a newly generated one, marking at the same time the old one as unusable, to prevent it from being re-used. The Association Module AM 12 is in charge with these operations.

The system may also include several central computers, in which case it must be implemented either a data storage solution common to these computers, or a periodical synchronization of data among the data storage systems of these computers.

The system is usually Stateless (without memorization of system status) and asynchronous, so that it is possible to scale the resources of the system according to distributed architectures, such as Grid Computing. If several PDM systems run simultaneously, the II generated must be unique in the entire system, and PII of receivers, together with II, must be able to be accessed by all PDM instances in the system. This is possible in the current example because the II list is generated and shared among all PDM systems by a joint database.

The method to optimize the reception and the transmission of personally identifiable information of the receiver, according to the invention, is illustrated in the flow chart in FIG. 4 and it consists in the following basic steps:
i)—introduce the personally identifiable information PII in the system, generate an impersonal identifier II unique in the system, and memorize the associated bijective pair PII-II, in an operative memory;
j)—transmit data by the emitter in the system with the use of the II generated in the previous step;
k)—process data in the system as regards the validation and associations with the suitable PII DPI, and transfer to an output device of the receiver according to the associated PII.

Introducing the personally identifiable information PII in the system, generate an impersonal identifier II unique in the system and memorize the pair associated bijective PII-II in an operative memory, according to step i—this implies, first of all, the transmission, by the receiver to the central computer, of its PII, preferably through a secured channel, for instance HTTPS. On the server computer, the received PII is validated, making sure both that the PII format is valid, for instance the electronic mail addresses respect the format described in RFC822, and that PII is unique in the system. If PII is not valid, then the receiver is notified of the issue, and the transmission process is resumed. If the PII is valid, then an impersonal identifier II is generated, it is associated in a bijective pair PII and II, and it is saved in a permanent operative memory every time, but also their association. The receiver may publish this II to any emitter.

As an II generation example, this may be obtained by concatenating 10 characters of the set {1, 2, 3, 4, 5, 6, 7, 8, 9, A, B, C, D, E, F, G, H, J, K, L, M, N, P, R, S, T, U, V, W, X, Y, Z} (the digit 0 and the letters I, O and Q are omitted to avoid the confusion if this Impersonal Identifier will also be introduced manually in the system). This means that, if we make combinations of all the 32 characters taken by 10 with repetition, the result will be a number corresponding to the combinations

$${C}_{k}^{n + k - 1} = \frac{( 32 + 10 - 1 ) !}{( 32 - 1 ) ! * 10 !} = 1 , 121 , 099 , 409$$

of Impersonal Identifiers. While II are associated with PII, there will be less and less II available, and to avoid the situation of remaining without II available, the number of characters forming the II may be increased, or new characters may be added to the initial assemblage. None of these two operations affect the II that have already been associated, or the operation of the PDM system. To avoid the creation of obscene words in II, they will be displayed in groups of two characters separated by hyphen. For instance, an II may be displayed as: AG-1T-M7-LL-5Y

The length average of an electronic mail address is bigger than the size of an II, therefore this PII may be more efficiently stored on an emitter's device.

As long as it is randomly selected and as long as it provides a bijective association with a PII, an II may be represented by any string of characters in any encoding system, or any other number in any numerical system. Another example of entity that may be generated to be used as II is an UUID (Universally Unique IDentifier), whose storage size is always of 32 bytes.

To implement Step j, respectively to transmit data by the emitter in the system with the use of the II generated in the previous step, an emitter “knows” the receiver's impersonal identifier II, it transmits data to the Receiver 8 by transmission of data and the II of the receiver towards the central computer.

As regards an emitter 1 provided with the feature of the option to manually introduce data, the emitter introduces the II of the receiver in a control (for instance, a text box), then it chooses the data that must be sent (text, sound, image, video, etc.), and it sends to the central computer the transmission request containing data and II.

As regards an emitter 1 where II is stored in a RFID device (Radio-Frequency IDentification), it is read by the emitter's device and automatically associated with the emitter's request to the central computer, so that the emitter must only select the data that it wishes to transmit.

As regards an emitter 1 where II is stored in a QR code (Quick Response) or alternative, there is the option to include II in a URI address (Uniform Resource Indicator) which refers to the central computer with the sub-system PDM, so that, when the emitter scans the QR code, it may be directly led to an web page where the data to be transmitted will be selected.

In the most general situation of an emitter 1 where II is stored in other unspecified manners in the accomplishment examples, it is necessary to make a specialized module for that type of storage that may read II so that it may be sent by the emitter to the PDM sub-system.

The removal of the need for manual introduction provides increased efficiency to the transmission of data to receivers, shortening the time to insert II and limiting the possibility to generate validation errors or to send data to a wrong receiver.

In order to process data in the system in terms of validation and associations with the corresponding PII and in order to transmit to a receiver output device, according to the associated PII, as explained in Step k, firstly the data in the emitter's request must be validated.

If the data is not valid, for instance if the sizes of the data are not in the required value range, then the emitter is notified of the issue, to be able to resume the transmission with the corrected parameters.

If the data is valid, then PDM interrogates the database to bring the PII corresponding to the II specified by the emitter. For performances on interrogation, II should work as a key to index PII in the stored data structure.

If PII cannot be found, for instance if II is marked as unusable or if an error occurred during the interrogation process, then the emitter is notified of the issue.

If the data is valid and PII has been found, then PDM transmits data and PII to the Data Expeditor Service DE. If necessary, an intermediate step is executed between PDM and DE, where the data and PII is transformed into a data structure compatible with the Communication Service Provider CSP. For instance, as regards a SMS, if PII contains the phone number without the country prefix and separately the country where the receiver has registered this number, PDM adds the prefix of the corresponding country to the phone number. DE connects to CSP and sends data together with PII.

CSP is the entity that issued the receiver's PII and it is the last node in the communication flow, having the function to transmit data to the data output device of the receiver according to this PII.

What is claimed:

1. A system for optimizing the transmission of data associated with an impersonal identifier of the receiver, whose architecture is made of the emitter 1 that “is made aware” of the impersonal identifier II, the input device 2 for the data to be transmitted by emitters and associated with a II unique in the system, the central computer 3 with server function which incorporates the Personal Data Manager sub-system PDM 9, optimizing the technical functional parameters of the system by using a “depersonalization” procedure of the specific PIT, destined to process data in the system in order to validate and associate it with the corresponding personally identifiable information PII and to transmit them to an output device 7 of the receiver according to the associated PII, the permanent Operative Memory OM 4 destined to memorize the II associated to PII, the Data Expeditor DE 5 which transmits data using PII to the communication service provider CSP 6, and the output device 7 to take over data by receiver 8.

2. System according to claim 1, where the Personal Data Manager sub-system PDM includes the Data Validation Module DVM 10, the Impersonal Identifier Generation Module IIGM 11, the Association Module AM 12 of PII with II, and the Data Structure Adjustment Module DSAM 13 that turns PII into a format accepted by the Communication Services Provider CSP.

3. Computer-implemented method for optimizing the transmission of data associated with an impersonal identifier of the receiver, the method comprising the steps of:
a. introducing personally identifiable information PII in the system, generate an impersonal identifier II that is unique in the system, and memorize the associated bijective PII-II pair in an operative memory;
b. transmitting the emitter's data in the system by using the II generated in the previous step;
c. processing the data in the system, by validation and association with the corresponding PII, and transmit the data to a receiver output device according to the associated PII.

4. The method according to claim 3, where in order to to insert the personally identifiable information PII in the system, to generate an impersonal identifier II unique in the system, and to memorize the associated bijective PII-II pair in an operative memory, further comprises the execution of the following sequences :
d. the receiver will transmit its PII to the central computer, preferably through a secured communication channel, for instance HTTPS;
e. the received PII is validated on the central computer that has a server role, making sure both that the PII format is valid (for instance the electronic mail addresses respect the format described in RFC822), and that the PII is unique in the system;
f. if the PII is not valid, then the receiver is notified of the issue, and the transmission process is restarted;
g. if the PII is valid, then an impersonal identifier II is generated and is a bijective association between the PII and the II is made;
e. PII, II and their association, are saved in a permanent operative memory.

5. The method according to claim 3, where in order transmit data by the emitter in the system with the use of the II generated in step 1, the emitter that is “made aware” of the impersonal identifier II of the receiver sends data to the receiver 9 by transmitting data and II of the receiver to the central computer working as server, further comprises the execution of the following logic:
h. as regards the option to insert data manually, the emitter types the II of the receiver in a control (for instance, a text box in the data input device), then it chooses the data that must be sent (text, sound, image, video, etc.), and it sends to the central computer a transmission request containing data and II;
i. if the II is stored in a RFID device (Radio-Frequency IDentification), it is read by the data input device of the emitter and automatically associated with the emitter's request to the central computer, so that the emitter adds to this request the data that must be transmitted;
j. if the II is stored in a QR code (Quick Response), there is the option to include the II in a URI address (Uniform Resource Indicator) referring to the PDM sub-system, so that when the emitter scans the QR code it may be directly led to a web page where it is sent as parameter II, and the emitter selects the data that must be transmitted to the receiver in the request to the central computer;
k. if the II is stored in another possible way, known as such but not specified in the accomplishment examples, its reading, reading II and its addition to the transmission request that is sent to the central computer is made through a specialized module for this specific storage manner, known as such.

6. The method according to claim 3 wherein order to process data in the system, with the purpose of validating and making associations with the corresponding PIT, and the transmission to a receiver output device according to the associated PII, further comprises the execution of the following sequences:
l. validate the data from the emitter's request;
m. if the data is not valid, for instance if the size of the data is not in a required interval of values, then the emitter is notified of the issue, to be able to restart the transmission with the corrected parameters;
n. if the data is valid, then MDP queries the database to bring the PII corresponding to II specified by the emitter. For performant queries, the PII data should be indexed and the II values should be used as the index keys;
o. if the PII cannot be found, for instance if II is marked as unusable or if an error occurred during the interrogation process, then the emitter will be notified of the issue;
p. if the data is valid and the PII has been found, MDP will transmit the data and PII to the Data Expeditor service DE, and, if it is necessary, an intermediate step will be taken between MDP and DE, when data and PII is transformed into a data structure compatible with the Communication Service Provider CSP;
q. DE is connected to CSP and transmits data together with PII.

7. A computer-readable storage medium containing computer-readable code for the programming of a server and a plurality of clients to perform the method according to claim 3.

8. A computer program product comprising a computer-readable medium having computer readable code embodied therein for performing the method according to claim 3.
